(19) United States
(12) Patent Application Publication
(10) Pub. No.: US 2008/0099324 A1
(43) Pub. Date: May 1, 2008

(54) Solar energy seawater desalination device

(76) Inventor: Yun-Nan Chiu, Taipei Hsien (TW)

Correspondence Address: Yun-Nan Chiu, 235 Chung-Ho, Box 8-24, Taipei, omitted

(21) Appl. No.: 11/586,704

(22) Filed: Oct. 26, 2006

(51) Int. Cl. C02F 1/04

(52) U.S. Cl. 203/10

(57) ABSTRACT

A solar energy seawater desalination device comprises a seawater tank for collecting seawater; a water absorption device for absorbing seawater from the seawater tank and then transferring the absorbed seawater, a water absorption solar energy plate for receiving the seawater from the water absorption device and absorbing solar energy and then converting the solar energy into heat energy so that the seawater evaporates and the vapor from the sea do not contain salt; at least one condensing plate for absorbing the vapor and condensing the vapor so that the condensed water flowing along the condensing plate; and a condensing water collecting tank placed at a lower side of the condensing plate for collecting the condensed water from the condensing plate.

### FIELD OF THE INVENTION

The present invention relates to a solar energy seawater desalination device, wherein the seawater can be desalinated by solar energy with higher efficiency. The solar energy is nature energy which is unnecessary to be converted into electric energy so that the cost is low and efficiency is high.

### BACKGROUND OF THE INVENTION

Due to the great increment of population and the improvement of human life, more and more fresh water (desalinated water) is needed.

Desalinating water is an effective way to resolve the problem of supply of fresh water and is a final way to resolve this problem. Because 70% of the surface of the earth is covered by seawater, the supply of seawater is no doubt in exhaustible. However, currently the cost for desalinating seawater is high and expensive and thus the desalinating water cannot be supplied as desired. Conventionally, the desalinating water needs a great amount of electric power. Currently, the deficiency of petroleum also increases the price of electric power and thus the cost of desalinating seawater is also increased.

However, the current trend for resolving the problem of energy supply is solar energy, but the technology for using solar energy is not so perfect. If the solar energy is converted into electric energy and then the electric energy is used in desalination, the cost is high and efficiency is low, which cannot be used to replace the conventional way for getting electric energy for petroleum energy.

Thus, there is an eager demand for a novel way for desalinating seawater by directly using solar energy which is not converted into electric power.

### SUMMARY OF THE INVENTION

Accordingly, the primary object of the present invention is to provide a solar energy seawater desalination device, wherein the seawater can be desalinated by solar energy with a high efficiency. The solar energy is nature energy which is unnecessary to be converted into electric energy so that the cost is low and efficiency is high.

To achieve above mentioned object, the present invention provides a solar energy seawater desalination device which comprises a seawater tank for collecting seawater; a water absorption device for absorbing seawater from the seawater tank and then transferring the absorbed seawater. a water absorption solar energy plate for receiving the seawater from the water absorption device and absorbing solar energy and then converting the solar energy into heat energy so that the seawater is evaporated and the vapor from the sea do not contain salt; at least one condensing plate for absorbing the vapor and condensing the vapor so that the condensed water flowing along the condensing plate; and a condensing water collecting tank placed at a lower side of the condensing plate for collecting the condensed water from the condensing plate. The various objects and advantages of the present invention will be more readily understood from the following detailed description when read in conjunction with the appended drawing.

### BRIEF DESCRIPTION OF THE DRAWINGS

FIG. 1 is a perspective view about the solar energy seawater desalination device of the present invention.

FIG. 2 is a lateral cross sectional view of the solar energy seawater desalination device of the present invention.

FIG. 3 is a lateral cross sectional view about another embodiment of the present invention.

FIG. 4 is a perspective view about the third embodiment of the solar energy seawater desalination device of the present invention.

FIG. 5 is a lateral cross sectional view of the third embodiment of the solar energy seawater desalination device of the present invention.

FIG. 6 is a lateral cross sectional view of the fourth embodiment of the solar energy seawater desalination device of the present invention.

FIG. 7 shows that the water absorption solar energy plate and the condensing plate can be realized by different objects.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

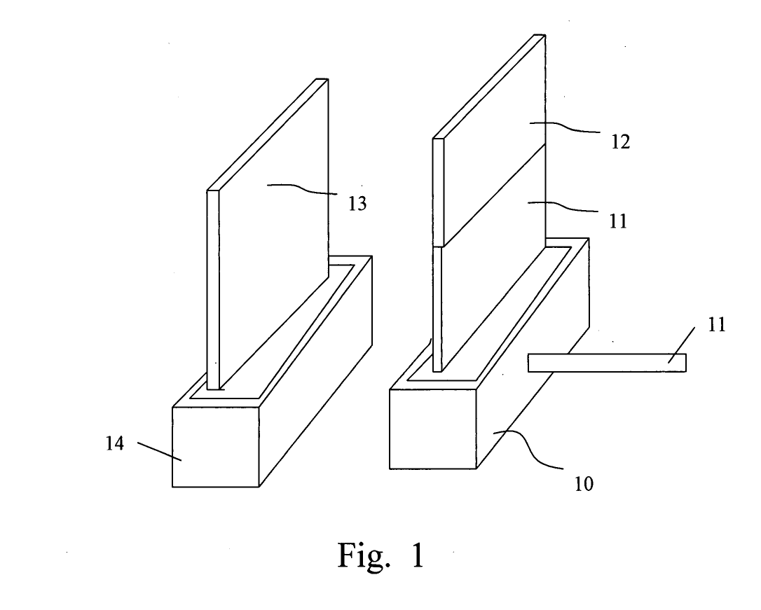

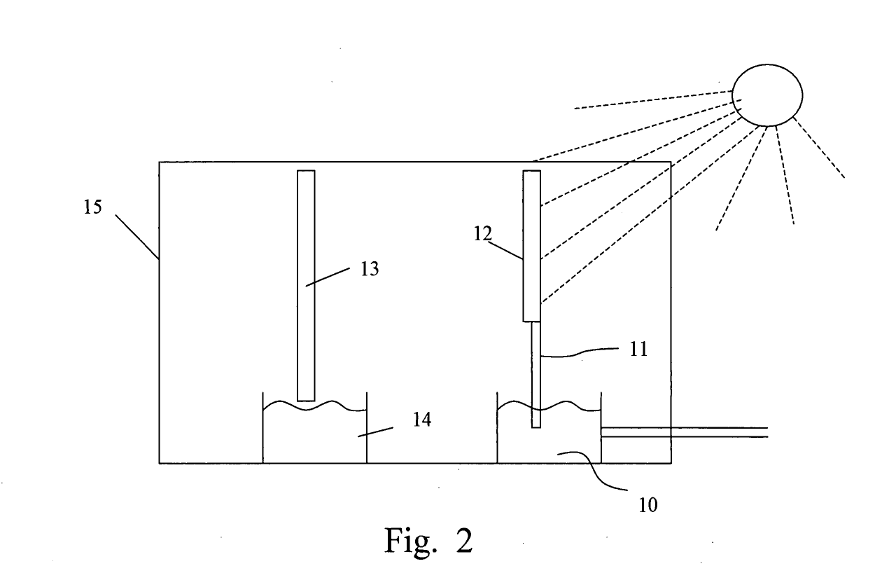

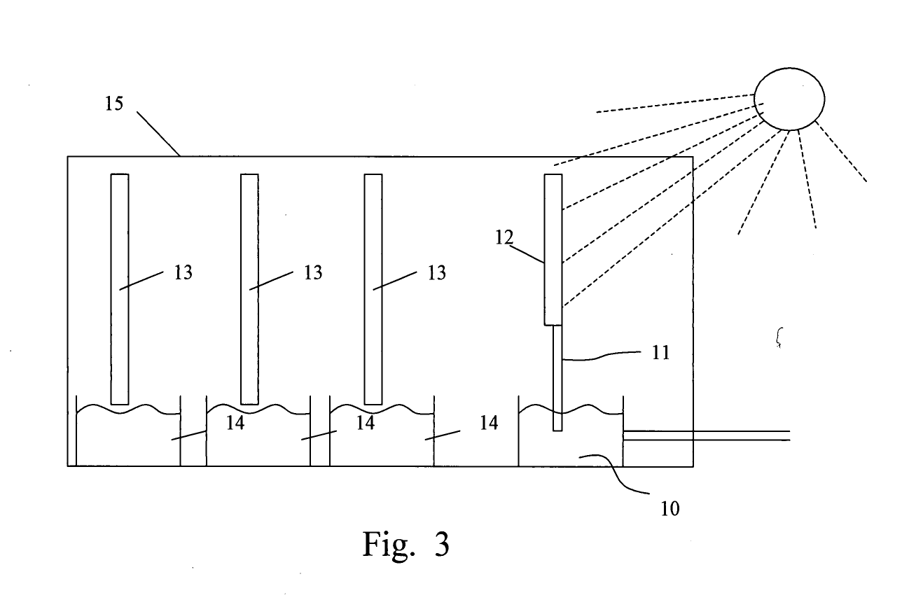

Referring to FIGS. 1 to 3, the solar energy seawater desalination device of the present invention is illustrated. The present invention has the following elements.

A seawater tank 10 serves for collecting seawater.

A water absorption device 11 serves for absorbing seawater from the seawater tank 10 and then transferring the absorbed seawater. The water absorption device 11 may be water absorption cloth which absorbs water by capillary action or other mechanic water absorbing devices.

A water absorption solar energy plate 12 serves for receiving the seawater from the water absorption device 11 and absorbing solar energy and then converting the solar energy into heat energy so that the seawater evaporates and the vapor from the sea do not contain salt and thus it is fresh water (desalinated water). The water absorption solar energy plate 12 is made of plate capable of absorbing solar energy, such as graphite plate, aluminum plate, especially, coated with black paints.

At least one condensing plate 13 serves for absorbing the vapor and condensing the vapor so that the condensed water flowing along the condensing plate 13. In the present invention, a plurality of condensing plates 13 are be installed. The condensing plates 13 are arranged to be distant to the solar energy plate 12 with different distances. Thereby when the vapor is not collect by a near condensing plate 13, it can be absorbed by following condensing plates 13.

A condensing water collecting tank 14 is placed at a lower side of the condensing plate 13 for collecting the condensed water from the condensing plate 13.

A cover 15 serves for covering above mentioned elements. A part of the cover 15 is transparent so that the solar light can incident into the cover 15 to enter into the solar energy plate 12.

In use, a plurality of solar energy seawater desalination devices can be arranged together for increasing the efficiency of energy absorbing.

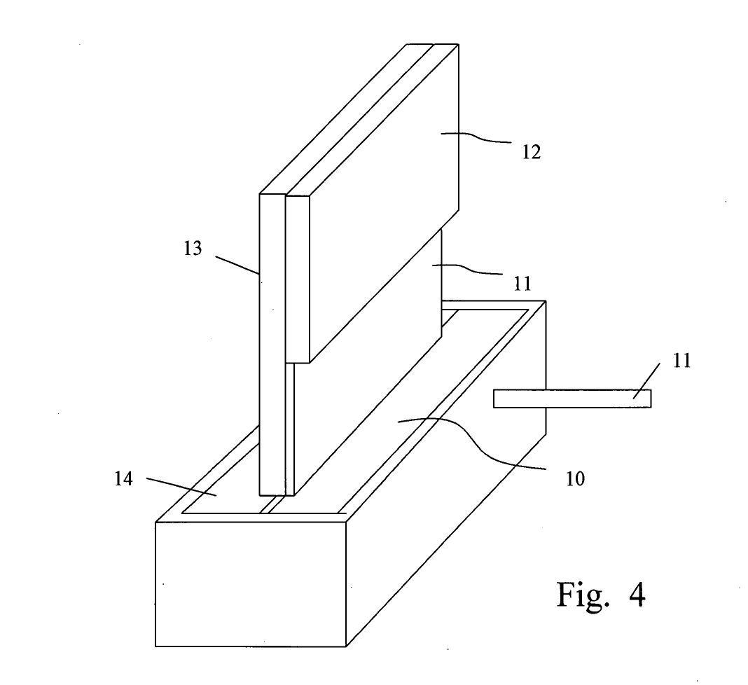

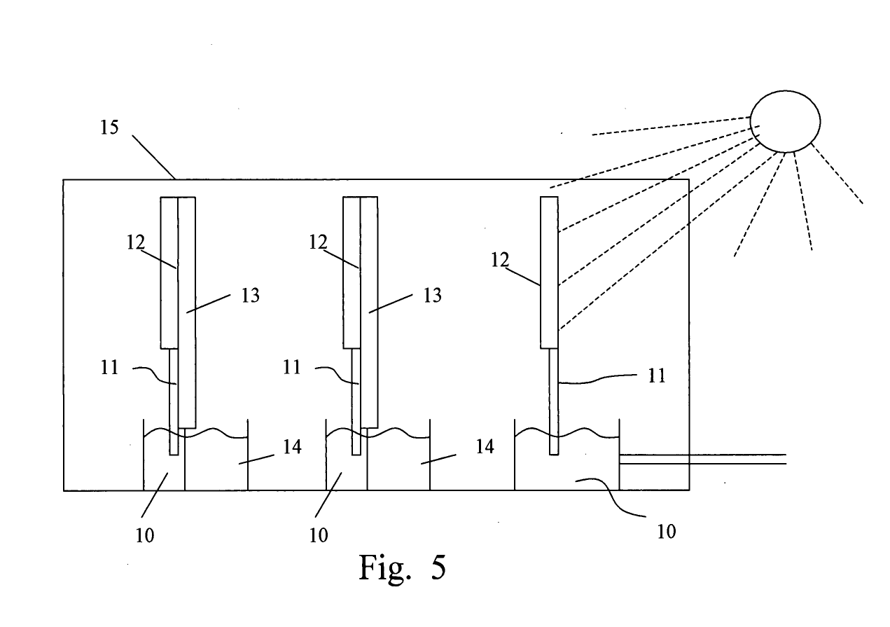

Referring to FIGS. 4 and 5, the third embodiment about the solar energy seawater desalination device of the present invention is illustrated. In this embodiment, those identical to the above mentioned embodiment will not be further described herein. Only those difference are disclosed. In the FIG. 4, it is illustrated that in the present invention, the water absorption solar energy plate 12 can be combined with the condensing plate 13, or a backside of the condensing plate 13 is added with a water absorption solar energy plate 12. A water absorption device 11 is installed at a lower side of the water absorption solar energy plate 12. A seawater tank 10 is laced at a backside of the condensing water collecting tank 14. The water absorption device 11 is inserted into the seawater tank 10 for absorbing seawater. In FIG. 5, it is illustrated that a plurality of these devices can be arranged sequentially.

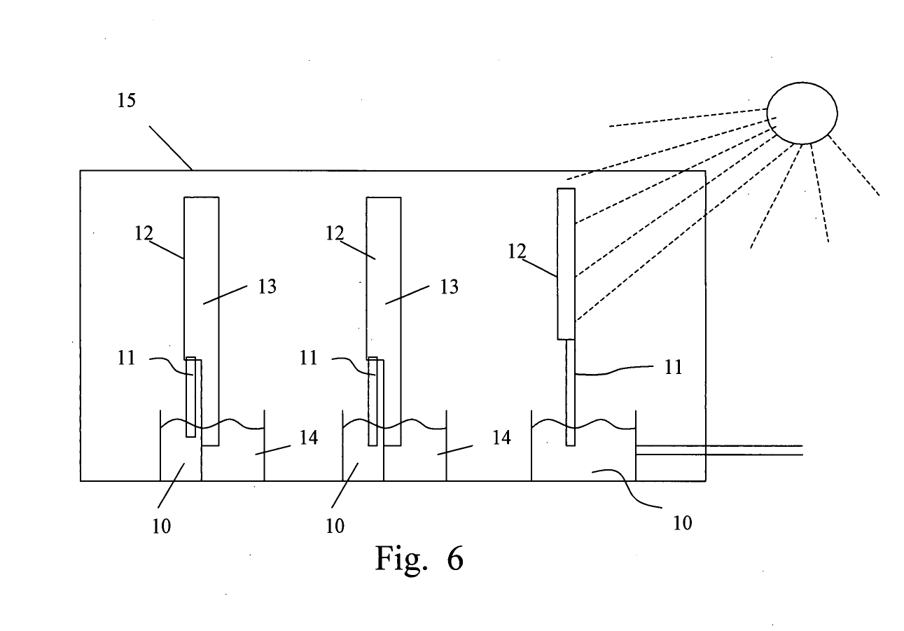

In FIG. 6, it is illustrated that the water absorption solar energy plate 12 and the condensing plate 13 are made of the same material.

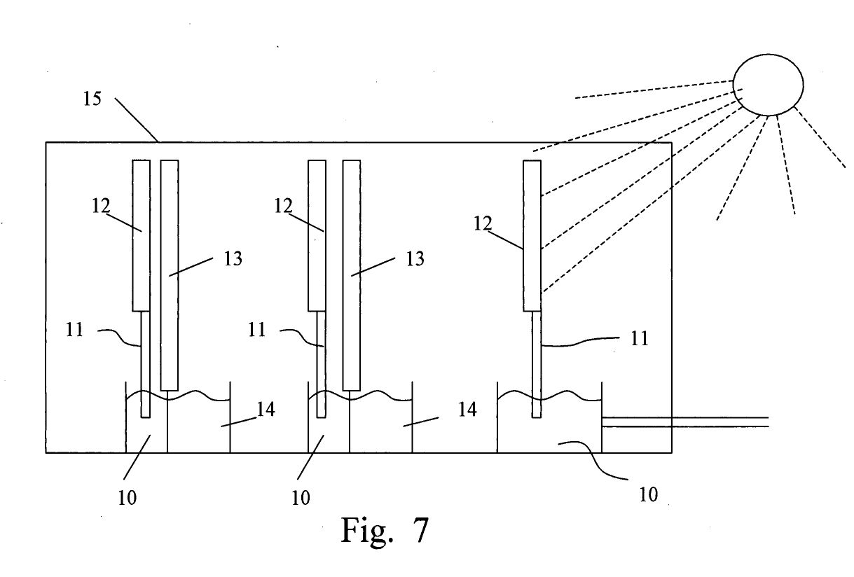

FIG. 7 shows that in the embodiment of FIG. 5, the water absorption solar energy plate 12 is separated with the condensing plate 13 with a predetermined distance.

Advantages of the present invention are that the seawater can be desalinated by solar energy with a high efficiency. The solar energy is nature energy which is unnecessary to be converted into electric energy so that the cost is low and efficiency is high.

In the present invention, a desalinating system can be added for removing the salt in the water absorption solar energy plate 12. However, this is known in the prior art and thus the details will not be further described herein.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A solar energy seawater desalination device comprising:
at least one seawater tank for collecting seawater;
at least one water absorption device for absorbing seawater from the seawater tank and then transferring the absorbed seawater;
at least one water absorption solar energy plate for receiving the seawater from the water absorption device and absorbing solar energy and then converting the solar energy into heat energy so that the seawater evaporates and the vapor from the sea do not contain salt;
at least one condensing plate for absorbing the vapor and condensing the vapor so that the condensed water flowing along the condensing plate; and
at least one condensing water collecting tank placed at a lower side of the condensing plate for collecting the condensed water from the condensing plate.

2. The solar energy seawater desalination device as claimed in claim 1, wherein the water absorption device is water absorption cloth which absorbs water by capillary action or other mechanic water absorbing devices.

3. The solar energy seawater desalination device as claimed in claim 1, wherein a plurality of condensing plates are installed; the condensing plates are arranged to be distant to the solar energy plate with different distances; thereby when the vapor is not collect by a near condensing plate, it can be absorbed by following condensing plates.

4. The solar energy seawater desalination device as claimed in claim 1, wherein the water absorption solar energy plate is made of plate capable of absorbing solar energy.

5. The solar energy seawater desalination device as claimed in claim 1, wherein the water absorption solar energy plate is made of one of graphite plate and aluminum plate.

6. The solar energy seawater desalination device as claimed in claim 5, wherein the water absorption solar energy plate is separated from the condensing plate.

7. The solar energy seawater desalination device as claimed in claim 1, further comprising a cover for covering above mentioned elements; a part of the cover is transparent so that the solar light can incident into the cover to enter into the solar energy plate.

8. The solar energy seawater desalination device as claimed in claim 1, wherein the water absorption solar energy plate is placed at a backside of the condensing plate.

9. The solar energy seawater desalination device as claimed in claim 1, wherein the water absorption solar energy plate is combined with the condensing plate, and the water absorption solar energy plate is made of the same material as that of the condensing plate.
